(19) United States
(12) Patent Application Publication
(10) Pub. No.: US 2013/0339181 A1
(43) Pub. Date: Dec. 19, 2013

(54) INFORMATION MANAGEMENT DEVICE, INFORMATION MANAGEMENT SYSTEM AND COMPUTER-READABLE RECORDING MEDIUM

(71) Applicants: CASIO INFORMATION SYSTEMS CO., LTD, Tokyo (JP); CASIO COMPUTER CO., LTD., Tokyo (JP)

(72) Inventors: Tatsuzi Ichikawa, Saitama (JP); Yoshiaki Yuyama, Tokyo (JP); Junichi Takei, Tokyo (JP); Kanoo Nakayama, Kanagawa (JP)

(73) Assignees: CASIO INFORMATION SYSTEMS CO., LTD, Tokyo (JP); CASIO COMPUTER CO., LTD., Tokyo (JP)

(21) Appl. No.: 13/895,526

(22) Filed: May 16, 2013

(30) Foreign Application Priority Data
Jun. 13, 2012 (JP) 2012-133432

(51) Int. Cl. G06Q 30/06

(52) U.S. Cl. CPC G06Q 30/0631
USPC 705/26.7

(57) ABSTRACT

An information management device which communicates with a mobile terminal, including a creating unit which creates advice information to be displayed on the mobile terminal for giving advice to a customer; a transmitting unit which transmits the advice information to the mobile terminal; and a requesting unit which transmits, to the mobile terminal, a deletion request for deleting the advice information, at a predetermined timing after transmission of the advice information.

### BACKGROUND OF THE INVENTION

1. Field of the Invention

The present invention relates to an information management device, an information management system and a computer-readable recording medium.

2. Description of Related Art

In conventional shops including beauty salons and so forth, information about customers have been hand-written on memo sheets by staffs who are in charge of the services. The staffs have been checking the memo sheets for references of services for the customers, when the customers come to the shops for the next time and thereafter.

On the other hand, there has been known a system for managing information about customers on the data basis. One known example refers to a customer management system which issues member cards to the customers at a shop such as beauty salon, and stores images of finished hairstyles of the customers identified by the member cards into a server for management (see Japanese Patent Application Laid Open Publication No. 2005-250932).

The customer management system has the server, and a personal computer connected to the server. Each member card has, recorded therein, an ID unique to each customer. After completion of service for a customer by a staff, the staff reads out the ID from the member card by using the personal computer, takes a photo of a finished hairstyle of the customer, and stores the image to the server. When the customer comes to the shop for the next time or thereafter, the staff reads out the ID from the member card by using the personal computer, reads the image of the past hairstyle corresponding to the ID from the server, and displays the image.

In the customer management system described above, the personal computer is stationarily placed in a predetermined area in the shop. Accordingly, the staff engaged in the service had to move from the area where the service is provided to the area where the personal computer is placed, if he or she wishes to know information about the customer in the course of the service in order to give some advice to the customer. In addition, the staff had to verify the information about the customer by operating the personal computer so as to display it.

One possible method of relieving the load of the staff is such as transmitting information about the customer from the personal computer to a mobile terminal carried by the staff, and displaying the information on it.

The configuration such as displaying the information about the customer on the mobile terminal for advice has, however, been suffering from a security risk regarding customer information possibly due to loss or theft of the mobile terminal per se, since the information regarding the customers is stored in the mobile terminal.

### SUMMARY OF THE INVENTION

It is, therefore, a main object of the present invention to inform the staff, by using the mobile terminal, of advice information to be directed to the customers, while preventing leakage of the advice information from the mobile terminal.

According to the first aspect of the present invention, there is provided an information management device which communicates with a mobile terminal, including a creating unit which creates advice information to be displayed on the mobile terminal for giving advice to a customer; a transmitting unit which transmits the advice information to the mobile terminal; and a requesting unit which transmits, to the mobile terminal, a deletion request for deleting the advice information, at a predetermined timing after transmission of the advice information.

According to the second aspect of the present invention, there is provided a non-transitory computer readable medium that stores a program for making a computer of an information management device which communicates with a mobile terminal execute a procedure, the procedure, comprising creating advice information to be displayed on the mobile terminal for giving advice to a customer; transmitting the advice information to the mobile terminal; and transmitting, to the mobile terminal, a deletion request for deleting the advice information, at a predetermined timing after transmission of the advice information.

According to the present invention, it is possible to inform a staff of advice information by using a mobile terminal and prevent leakage of the advice information from the mobile terminal.

### BRIEF DESCRIPTION OF THE DRAWINGS

The above and other objects, advantages and features of the present invention will become more fully understood from the detailed description given hereinafter and the appended drawings which are given by way of illustration only, and thus are not intended as a definition of the limits of the present invention, and wherein:

FIG. 1 is a block diagram illustrating an information management system according to an embodiment of the present invention;

FIG. 2 is a block diagram illustrating a functional configuration of an information management device;

FIG. 3 is a block diagram illustrating a functional configuration of a mobile terminal;

FIG. 4A is a drawing illustrating staff information;

FIG. 4B is a drawing illustrating customer information;

FIG. 5A is a drawing illustrating appointment information;

FIG. 5B is a drawing illustrating history information;

FIG. 5C is a drawing illustrating conversation keyword information;

FIG. 6 is a drawing illustrating advice information;

FIG. 7 is a flow chart illustrating an advice information transmission process executed on the information management device;

FIG. 8 is a flow chart illustrating an advice information creation process in the advice information transmission process;

FIG. 9 is a flow chart illustrating an advice information display process executed on the mobile terminal;

FIG. 10 is a drawing illustrating an advice information screen;

FIG. 11A is a flow chart illustrating a service course end information transmission process executed on the information management device;

FIG. 11B is a flow chart illustrating a service course end information display process executed on the mobile terminal;

FIG. 12A is a flow chart illustrating an advice information deletion request process executed on the information management device;

FIG. 12B is a flow chart illustrating an advice information deletion process executed on the mobile terminal;

FIG. 13A is a flow chart illustrating a customer photographing process executed on the mobile terminal;

FIG. 13 B is a flowchart illustrating a memo information creation process executed on the mobile terminal;

FIG. 14 is a flow chart illustrating an information reception process executed on the information management device.

### DETAILED DESCRIPTION OF THE PREFERRED EMBODIMENT

Embodiments of the present invention will be detailed below, referring to the attached drawings. Note that the present invention is not limited to the illustrated examples.

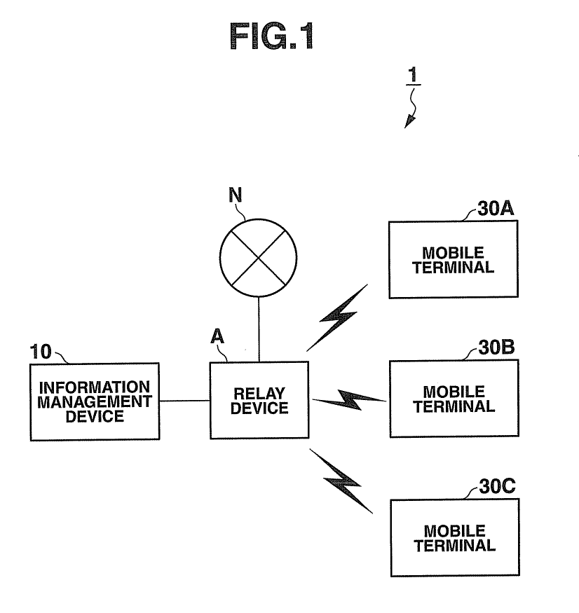

An overall configuration of a device according to an embodiment of the present invention will be explained referring to FIG. 1. FIG. 1 is a block diagram illustrating an information management system 1 of this embodiment.

As illustrated in FIG. 1, the information management system 1 is installed in a shop of beauty salon. The shop of beauty salon includes a reception counter where reception of customers and accounting take place, a service area where staffs or salon workers provide main services to the customers, and a hair-washing area where assistants of the staffs wash hair of the customers.

The information management system 1 has an information management device 10, a relay device A, and mobile terminals 30A, 30B and 30C. The information management device 10 is an information processing device installed at the reception counter, and is used for reception of customers, accounting, information management of the shop, and customer service management through the mobile terminals 30A, 30B and 30C.

The information management device 10 establishes wireless communication through the relay device A with the mobile terminals 30A, 30B and 30C. The relay device A functions as an access point, and has a wired connection to the information management device 10 and wireless connections to the mobile terminals 30A, 30B and 30C to thereby relay communication between the information management device 10 and each of the mobile terminals 30A, 30B and 30C. The relay device A also functions as a router, and is connected to a communication network N. The communication network N is the Internet. The information management device 10 wirelessly communicates through the relay device A with the mobile terminals 30A, 30B and 30C, and communicates with equipment on the communication network N.

The mobile terminals 30A, 30B and 30C are information processing terminals in the form of tablet terminal or the like respectively used by three staffs. Note that the user of the mobile terminal 30A is not limited to a single staff, and the same will also apply to the mobile terminals 30B and 30C. However, the mobile terminals 30A, 30B and 30C may be dedicated respectively to the three staffs. The number of mobile terminals is not limited to three. The mobile terminals 30A, 30B and 30C enable communication with the information management device 10, display and storage of information, and in particular function as customer service assisting devices by displaying thereon advice information, which is information for assisting the staffs to give advice to the customers in the course of the services.

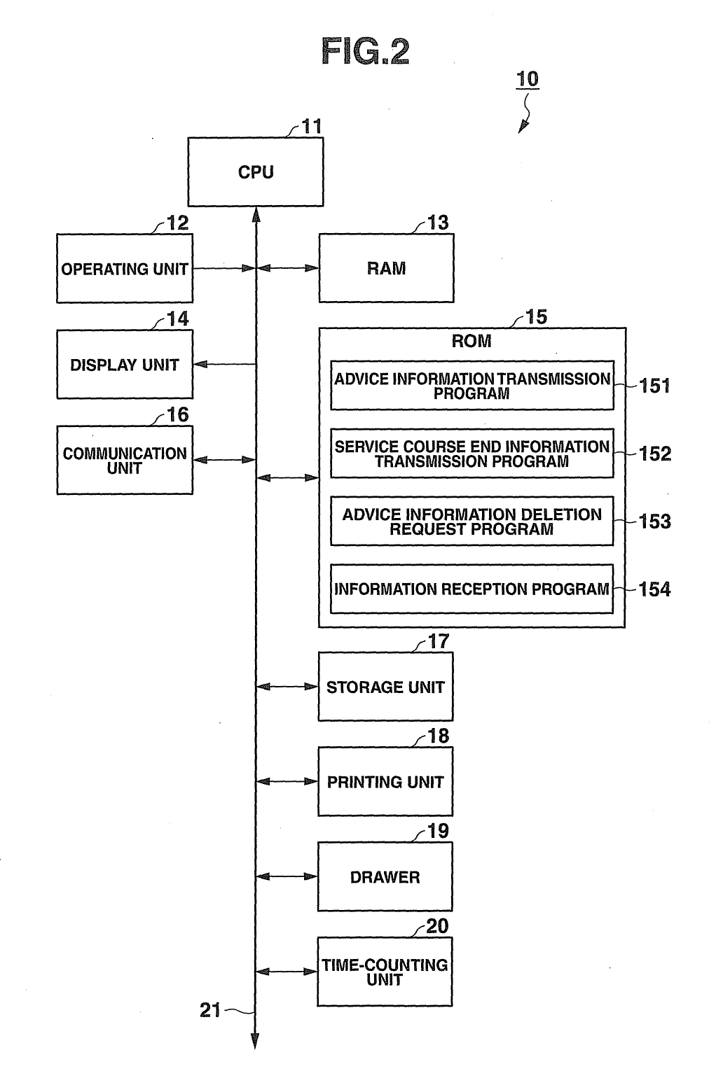

Next, an internal functional configuration of the information management device 10 will be explained referring to FIG. 2.

FIG. 2 is a block diagram illustrating the functional configuration of the information management device 10.

As illustrated in FIG. 2, the information management device 10 has a CPU (Central Processing Unit) 11 which functions as a creating unit, a transmitting unit and a requesting unit, an operating unit 12, a RAM (Random Access Memory) 13, a display unit 14, a ROM (Read Only Memory) 15, a communication unit 16 which functions as an advice information transmission unit and an advice information deletion requesting unit, a storage unit 17 which functions as a first storage unit, a printing unit 18, a drawer 19, and a time-counting unit 20. The individual sections of the information management device 10 are mutually connected through a bus 21.

The CPU 11 controls the individual sections of the information management device 10. The CPU 11 reads a specified program among various programs from the ROM 15, loads it into the RAM 13, and executes various processes in cooperation with the loaded program.

According to an advice information transmission program 151, and in response to visit of a customer, the CPU 11 creates advice information 100 by using customer information 60, history information 80 and appointment information 70 of the customer, and sends the advice information 100 through the communication unit 16 to the mobile terminal 30A, 30B or 30C. According to a service course end information transmission program 152, and in response to entry operation by the assistant of the staff through the operating unit 12, the CPU 11 also sends service course end information which indicates the end of shampoo course, through the communication unit 16 to the mobile terminal of the staff. According to an advice information deletion request program 153, and in response to the end of accounting, the CPU 11 also sends an advice information deletion request which requests the mobile terminal to delete the advice information, through the communication unit 16 to the mobile terminal. According to an information reception program 154, and in response to information received from the mobile terminal, the CPU 11 also updates history information 80 stored in the storage unit 17.

The operating unit 12 is a touch panel formed on the screen of the display unit 14, accepts touch input by the user, and outputs operation information corresponding to the touch input to the CPU 11. The operating unit 12 can accept key-touch input of various characters, various functions and so forth. The operating unit 12 may also be configured to have a plurality of physical keys.

The RAM 13 is a volatile semiconductor memory, and has a work area for storing various data and various programs.

The display unit 14 has a display panel such as LCD (Liquid Crystal Display), EL (ElectroLuminescent) display, and shows various contents on the display panel, according to display information received from the CPU 11.

ROM 15 is a read-only semiconductor memory which stores various data and various programs. The ROM 15 stores an advice information transmission program 151, a service course end information transmission program 152, an advice information deletion request program 153 and an information reception program 154.

The communication unit 16 is configured by containing a network card or such like for establishing communication with the relay device A. The CPU 11 uses the communication unit 16 to communicate, through the relay device A, with the equipment on the communication network N, and wirelessly communicates with the mobile terminals 30A, 30B and 30C.

The storage unit 17 is a flash memory for storing information in a readable and writable manner, an EEPROM (Electrically Erasable Programmable ROM), or a non-volatile memory such as RAM backed up by battery. In the storage unit 17, staff information 50 described later, the customer information 60, the appointment information 70, the history information 80, conversation keyword information 90 and the advice information 100 are stored.

The printing unit 18 is typically a thermal printer which prints information on a sheet of paper such as receipt paper. The printing unit 18 prints information on a sheet of paper as instructed by the CPU 11.

The drawer 19 has a cash drawer box which pools cash and gift certificate, and a releasing mechanism, and is configured to release the cash drawer box with the aid of the releasing mechanism, as instructed by the CPU 11. The cash drawer box released by the drawer 19 is again closed manually by the staff.

The time-counting unit 20 has a timer circuit which keeps current date and time information, and outputs the current date and time information to the CPU 11.

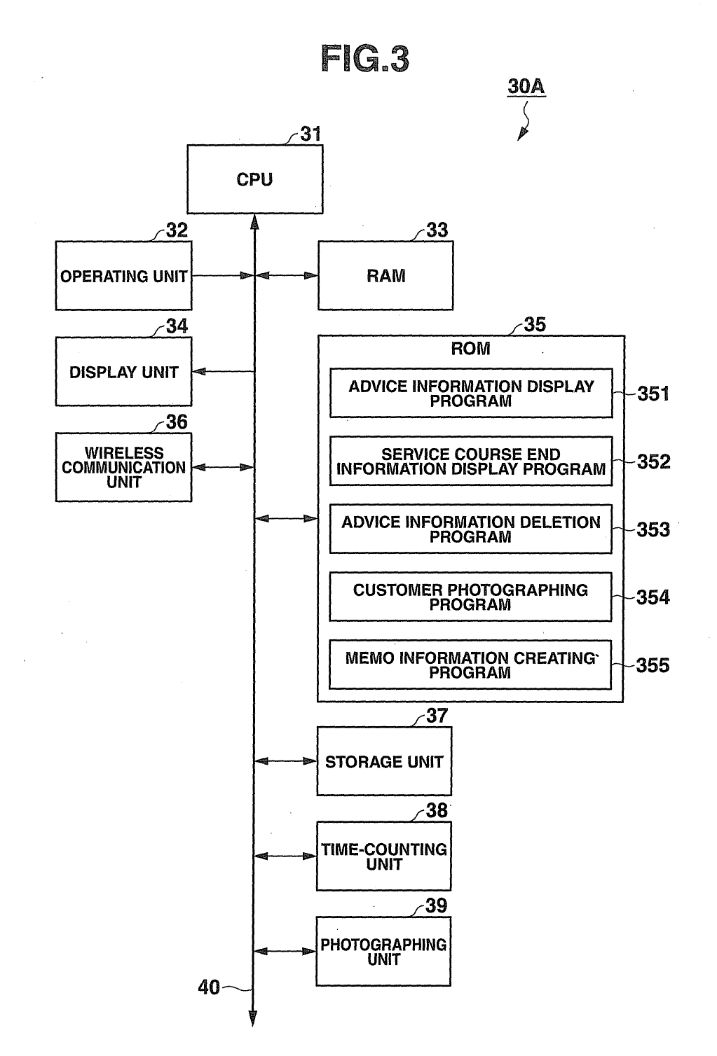

Next, an internal functional configuration of the mobile terminal 30A will be explained referring to FIG. 3. FIG. 3 is a block diagram illustrating a functional configuration of the mobile terminal 30A. While the description below will representatively deal with the mobile terminal 30A, the same will also apply to the mobile terminals 30B and 30C.

As illustrated in FIG. 3, the mobile terminal 30A has a CPU 31 which functions as a receiving unit and a control unit, an operating unit 32, a RAM 33, a display unit 34 which functions as an informing unit, a ROM 35, a wireless communication unit 36 which functions as a receiving unit, a storage unit 37 which functions as a second storage unit, a time-counting unit 38 and a photographing unit 39. The individual sections of the mobile terminal 30A are mutually connected through a bus 40.

The CPU 31, the operating unit 32, the RAM 33, the display unit 34, the ROM 35, the storage unit 37 and the time-counting unit 38 respectively have functions same as those of the CPU 11, the operating unit 12, the RAM 13, the display unit 14, the ROM 15, the storage unit 17 and the time-counting unit 20 of the information management device 10. The description below will mainly deal with different aspects to avoid repetitive explanation.

The CPU 31 controls the individual sections of the mobile terminal 30A. According to an advice information display program 351 stored in the ROM 35, on the mobile terminal logged in by the staff engaged in the service, the CPU 31 receives the advice information 100 through the wireless communication unit 36 from the information management device 10, and displays it on the display unit 34. According to a service course end information display program 352, the CPU 31 also receives the service course end information sent from the information management device 10 through the wireless communication unit 36, and displays it on the display unit 34.

According to an advice information deletion program 353, the CPU 31 also receives an advice deletion request sent from the information management device 10 through the wireless communication unit 36, and deletes, according to the advice deletion request, the advice information 100 stored in the storage unit 37.

According to a customer photographing program 354, the CPU 31 also allows the photographing unit 39 to take a picture of the customer's head (hairstyle) after finished by the staff, and sends finished style image data through the wireless communication unit 36 to the information management device 10.

According to memo information creating program 355, the CPU 31 also allows the photographing unit 39 to photograph and read a memo which is written by the staff after completion of the customer's service, creates memo information, and sends the memo information through the wireless communication unit 36 to the information management device 10.

In the ROM 35, the advice information display program 351, the service course end information display program 352, the advice information deletion program 353, the customer photographing program 354 and the memo information creating program 355 are stored.

The wireless communication unit 36 has a wireless communication antenna, and a communication circuit containing a modulator, a demodulator and so forth, and establishes wireless communication with the relay device A. The CPU 31 allows the wireless communication unit 36 to establish communication through the relay device A with the information management device 10. In the storage unit 37, the advice information 100 is stored.

The photographing unit 39 has an optical system, a photographing element and so forth, and is configured to take pictures of objects. Corresponding to photographing operation by the staff made on the operating unit 12, the photographing unit 39 photographs the finished customer's head (hairstyle), or a memo written by the staff after the service, and outputs the obtained image data to the storage unit 37.

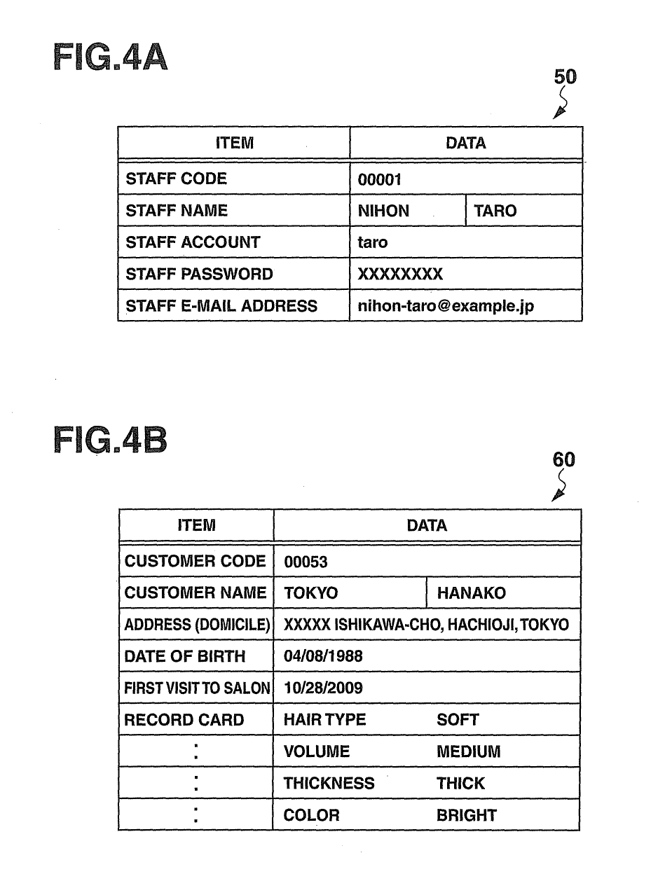

Next, information stored in the storage unit 17 of the information management device 10 will be explained referring to FIGS. 4A to 6. FIG. 4A is a drawing illustrating the staff information 50. FIG. 4B is a drawing illustrating the customer information 60.

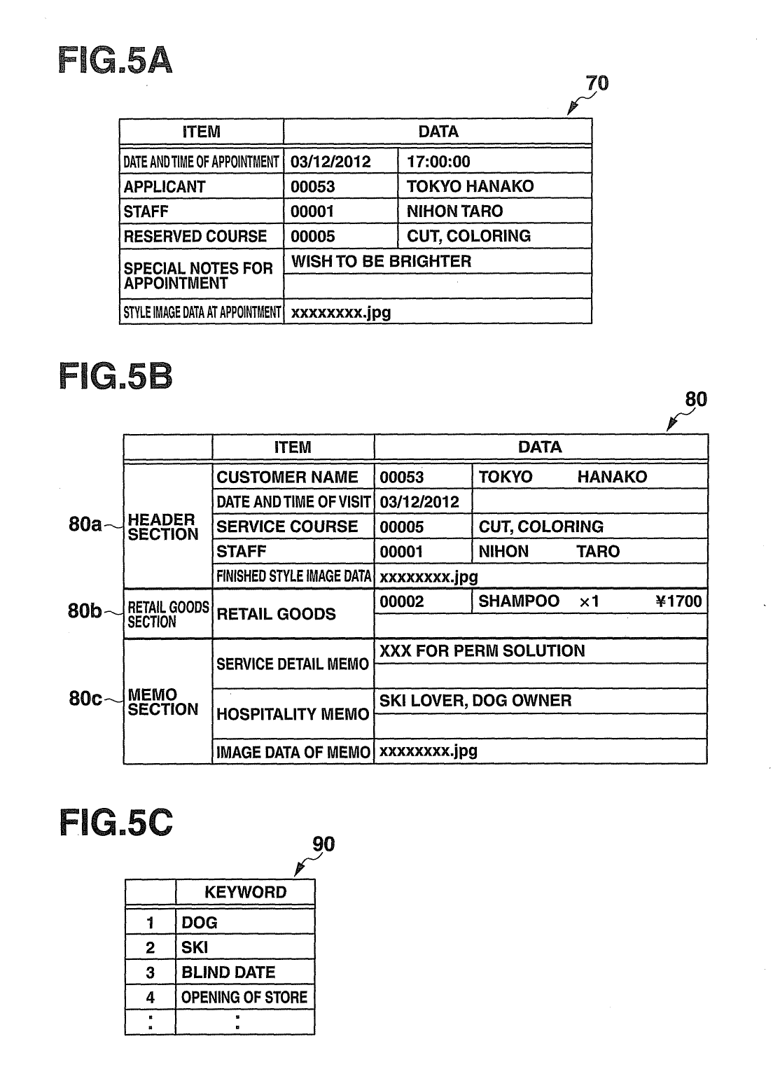

FIG. 5A is a drawing illustrating the appointment information 70. FIG. 5B is a drawing illustrating the history information 80. FIG. 5C is a drawing illustrating the conversation keyword information 90.

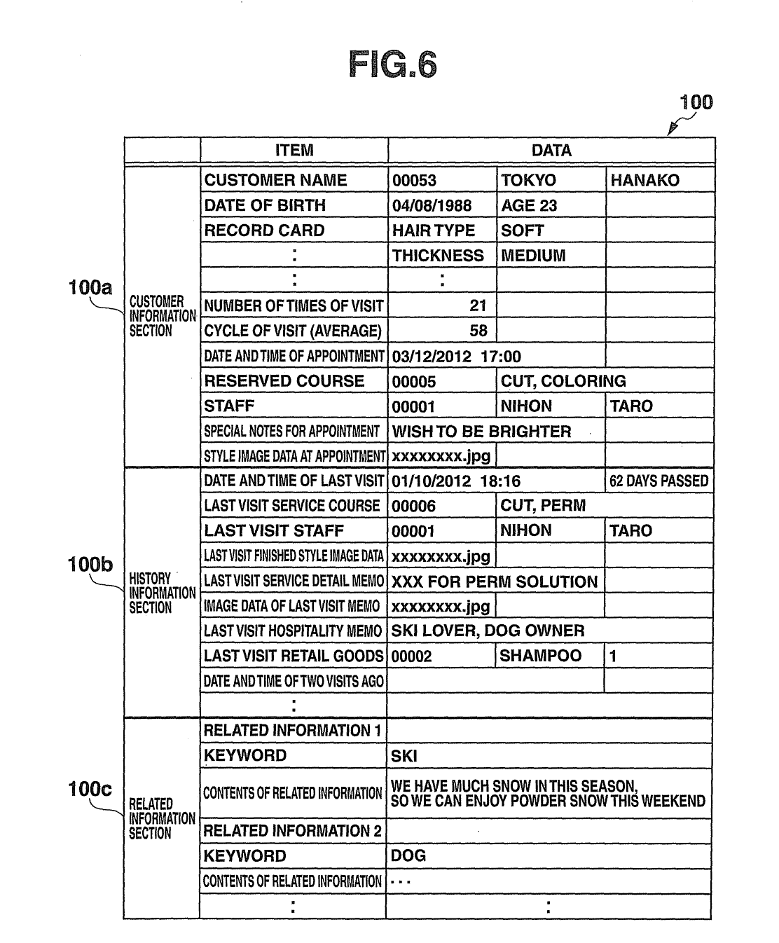

FIG. 6 is a drawing illustrating the advice information 100.

The staff information 50 illustrated in FIG. 4A is personal information of the individual staffs who belong to the shop where the information management device 10 is installed. The staff information 50 is, for example, created according to entries made by an administrator who operates the operating unit 12. The staff information 50 contains names and data of the individual items including staff code, staff name, staff account, staff password and staff email address.

The staff code in the staff information 50 represents information for identifying the staffs. The staff name in the staff information 50 represents staff names identified by the staff codes. The staff account in the staff information 50 represents accounts used by the staffs identified by the staff codes. The staff password in the staff information 50 represents passwords used for log-in by the staffs identified by the staff codes. The staff email address in the staff information 50 represents email addresses of personal mobile terminals, such as mobile phones, owned by the staffs identified by the staff codes.

The customer information 60 illustrated in FIG. 4B is individualized personal information of the customers of the salon where the information management device 10 is installed. The customer information 60 is typically created in response to entry operation through the operating unit 12 by the administrator. The customer information 60 contains names and data of the individual items including customer code, customer name, address (domicile), date of birth, first visit to shop, and record card.

The customer code in the customer information 60 represents information for identifying the customers. The customer name in the customer information 60 represents customer names identified by the customer code. The address (domicile) in the customer information 60 represents addresses (domiciles) of the customers identified by the customer codes. The date of birth in the customer information 60 represents dates of birth of the customers identified by the customer codes. The first visit to shop in the customer information 60 represents years and dates of first visit of the customers identified by the customer codes. The record card in the customer information 60 contains hair types of the customers identified by the customer codes. The record card typically contains hair types (hard, medium or soft), volume (much, medium or less), thickness (thick, medium or thin) and color (bright, medium or dark).

The appointment information 70 illustrated in FIG. 5A is individualized information of appointments of the shop where the information management device 10 is installed, made by the customers. The appointment information 70 is typically created in response to entry operation through the operating unit 12 by a clerk (administrator, staff). The appointment information 70 contains names and data of the individual items including date and time of appointment, applicant, staff, reserved course, special notes for appointment, and style image data at appointment.

The date and time of appointment in the appointment information 70 represents appointed dates and times for the services. The applicant in the appointment information 70 represents the customer codes and the customer names of the customers who made appointments. The staff in the appointment information 70 represents the staff codes and the staff names of the staffs scheduled for the services based on choice by the customers or assignment of the staffs. The reserved course in the appointment information 70 represents the code information and course names of the appointed service courses. The special notes for appointment in the appointment information 70 represents special notes on the appointments. The style image data at appointment in the appointment information 70 represents file names of image data of hairstyle samples desired by the customers who made appointments, and may contain addresses in the storage unit 17 where the image data are stored.

The history information 80 illustrated in FIG. 5B represents individualized service history of the customers of the shop where the information management device 10 is installed. The history information 80 contains a header section 80a, a retail goods section 80b and a memo section 80c.

The header section 80a contains names and data of the individual items including customer name, date of visit, service course, staff, and the finished style image data. The customer name in the header section 80a represents the customer codes and the customer names of the customers who receive the services. The date of visit in the header section 80a represents dates and times of visit of the customers who receive the services. The service course in the header section 80a represents the code information and the course names of the courses directed to the customers. The staff in the header section 80a represents the staff codes and the staff names of the staffs responsible for the service. The finished style image data in the header section 80a represents file names of image data of finished hairstyles of the customers, and may contain addresses in the storage unit 17 where the image data are stored.

The retail goods section 80b contains item names and data of the retail goods. The retail goods in the retail goods section 80b contains code information, name of retail goods, quantity, and price of the retail goods sold on the date of visit contained in the header section 80a.

The memo section 80c contains item names and data of the individual items including service detail memo, hospitality memo, and image data of memo. The service detail memo in the memo section 80c represents text data regarding details of service written by the staff on a memo sheet corresponding to the service course contained in the header section 80a.

The hospitality memo in the memo section 80c represents text data regarding contents of talk of the customer, written by the staff on a memo sheet corresponding to the service course contained in the header section 80a. The image data of memo in the memo section 80c represents a file name of image data of memo containing illustration regarding details of service, written by the staff corresponding to the service course contained in the header section 80a, and may contain addresses in the storage unit 17 where the image data are stored.

The conversation keyword information 90 illustrated in FIG. 5C represents a keyword used for acquiring information regarding the contents of talk contained in the hospitality memo. The keyword is preferably a character string such as a word regarding topic, about which the customer prefers to obtain related information.

For example, if the hospitality memo contains “ski” as a hobby, snow condition is acquired as the related information regarding “ski” by web search using “ski” as a keyword. The keyword of the conversation keyword information 90 contains, for example, dog, ski, blind date, opening of store and so forth.

The advice information 100 illustrated in FIG. 6 is used for making advice from the staff to the customer in the course of the service. The advice information 100 has a customer information section 100a, a history information section 100b and a related information section 100c.

The customer information section 100a contains item names and data of the individual items including customer name, date of birth, record card, number of times of visit, cycle of visit (average), date and time of appointment, reserved course, staff, special notes for appointment, and style image data at appointment. The customer name, the date of birth, and the record card in the customer information section 100a are respectively same as the customer name, the date of birth, and the record card in the customer information 60 corresponding to the customer to receive the service.

The number of times of visit in the customer information section 100a represents the total number of times of visit of the customer to receive the service, and is equal to the number of history information of the customer. The cycle of visit (average) in the customer information section 100a represents an average number of days of cycle of visit of the customer to receive the service. The date and time of appointment, the reserved course, the staff, the special notes for appointment, and the style image data at appointment in the customer information section 100a are respectively same as the date and time of appointment, the reserved course, the staff, the special notes for appointment, and the style image data at appointment in the appointment information 70 corresponding to the customer to receive the service.

The history information section 100b contains item names and data of the individual items for the last service, including items regarding date and time of last visit, last visit service course, last visit staff, last visit finished style image data, last visit service detail memo, image data of last visit memo, last visit hospitality memo, items regarding last visit retail goods, and the same items for the services earlier than the last time service, such as the service of two visits ago.

The date and time of last visit, the last visit service course, the last visit staff, the last visit finished style image data, the last visit service detail memo, the image data of last visit memo, the last visit hospitality memo, and the last visit retail goods in the history information section 100b are respectively same as the date and time of visit, the service course, the staff, the finished style image data, the service detail memo, the image data of memo, the hospitality memo, and the retail goods in the history information 80 for the last visit.

The related information section 100c contains information in connection with the keywords extracted from the hospitality memo in the history information 80, using the conversation keyword information 90. While the related information section 100c herein contains the related information in connection with the keywords in the last visit hospitality memo in the history information section 100b, the related information is not limited thereto. The related information section 100c contains item names and data of the individual items including keyword and contents of the related information, for each of the related information (keywords).

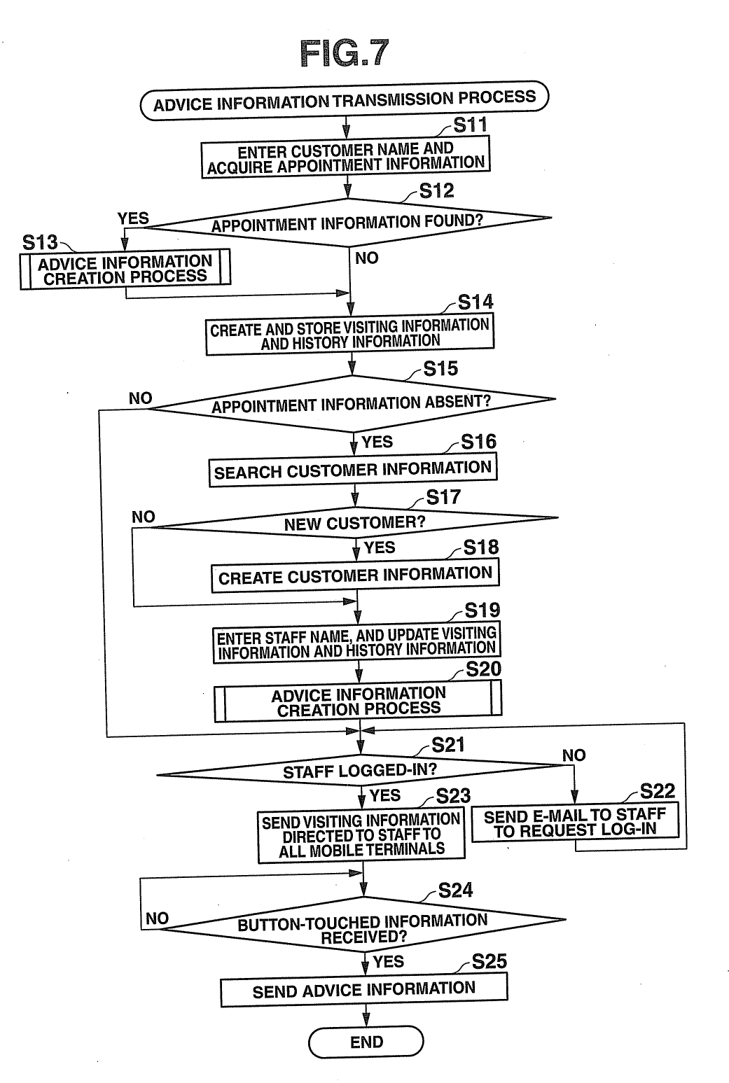

Next, operations of the information management system 1 will be explained referring to FIGS. 7 to 14.

FIG. 7 is a flow chart illustrating an advice information transmission process executed on the information management device 10.

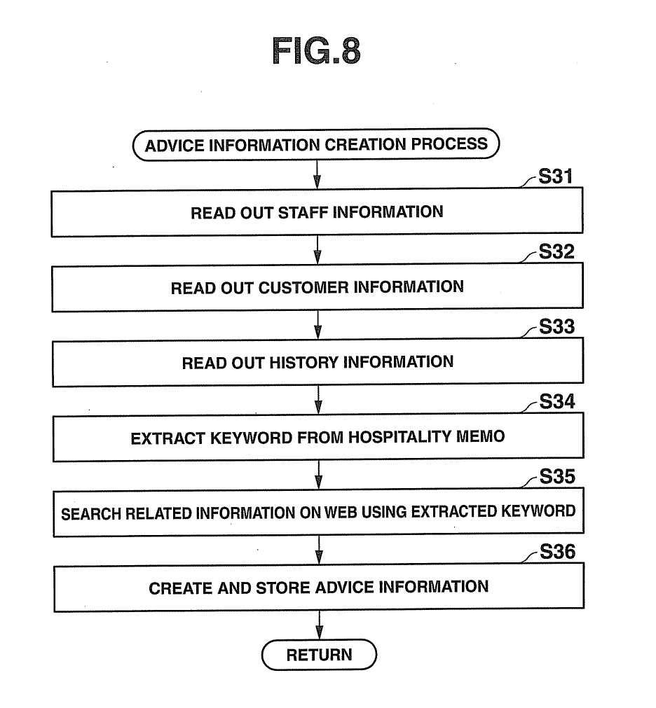

FIG. 8 is a flow chart illustrating an advice information creation process in the advice information transmission process.

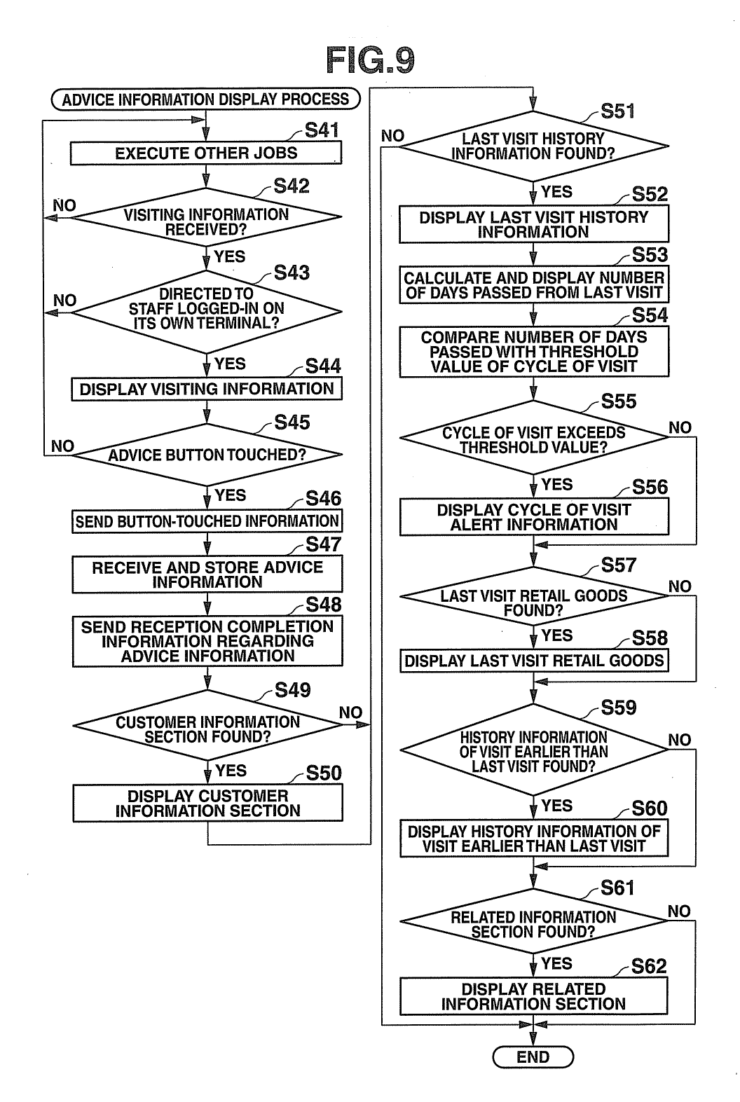

FIG. 9 is a flow chart illustrating an advice information display process executed on the mobile terminal 30A.

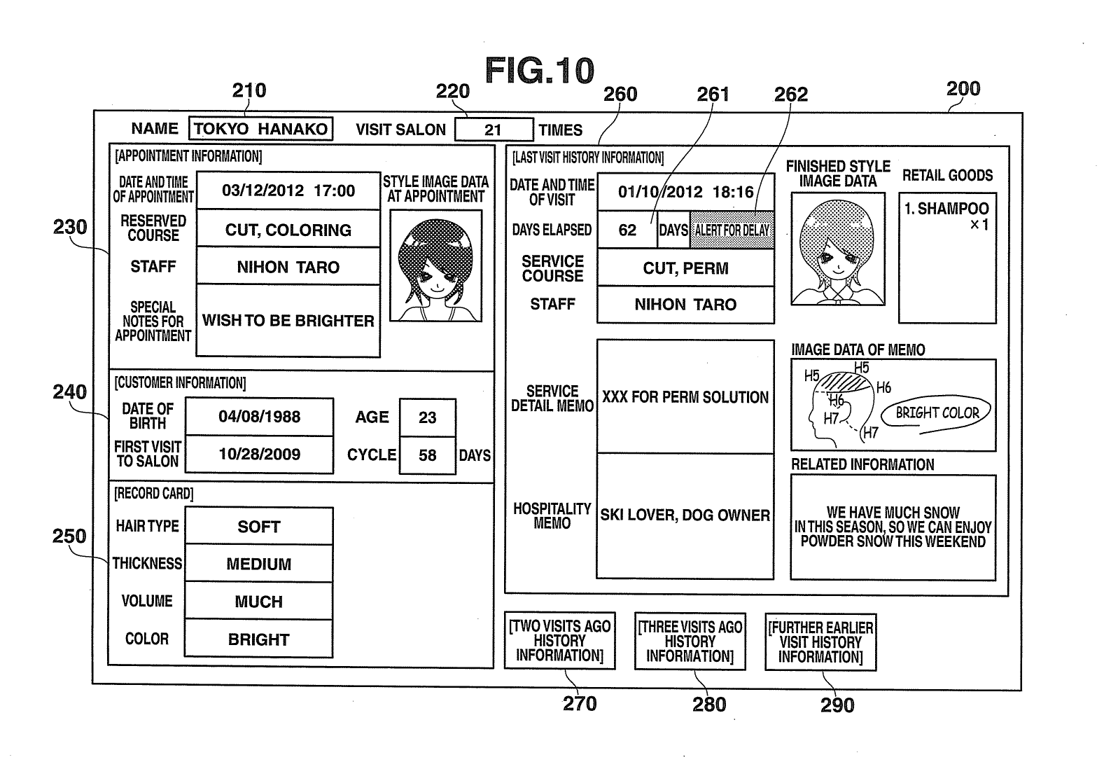

FIG. 10 is a drawing illustrating an advice information screen 200.

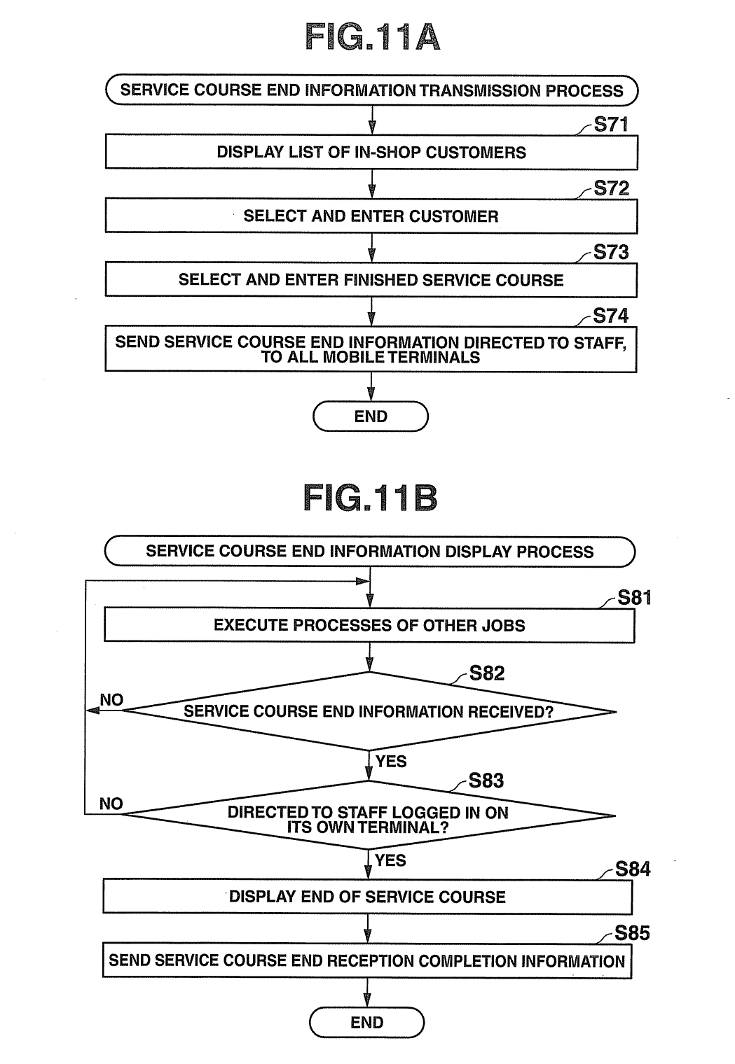

FIG. 11A is a flow chart illustrating a service course end information transmission process executed on the information management device 10.

FIG. 11B is a flow chart illustrating a service course end information display process executed on the mobile terminal 30A.

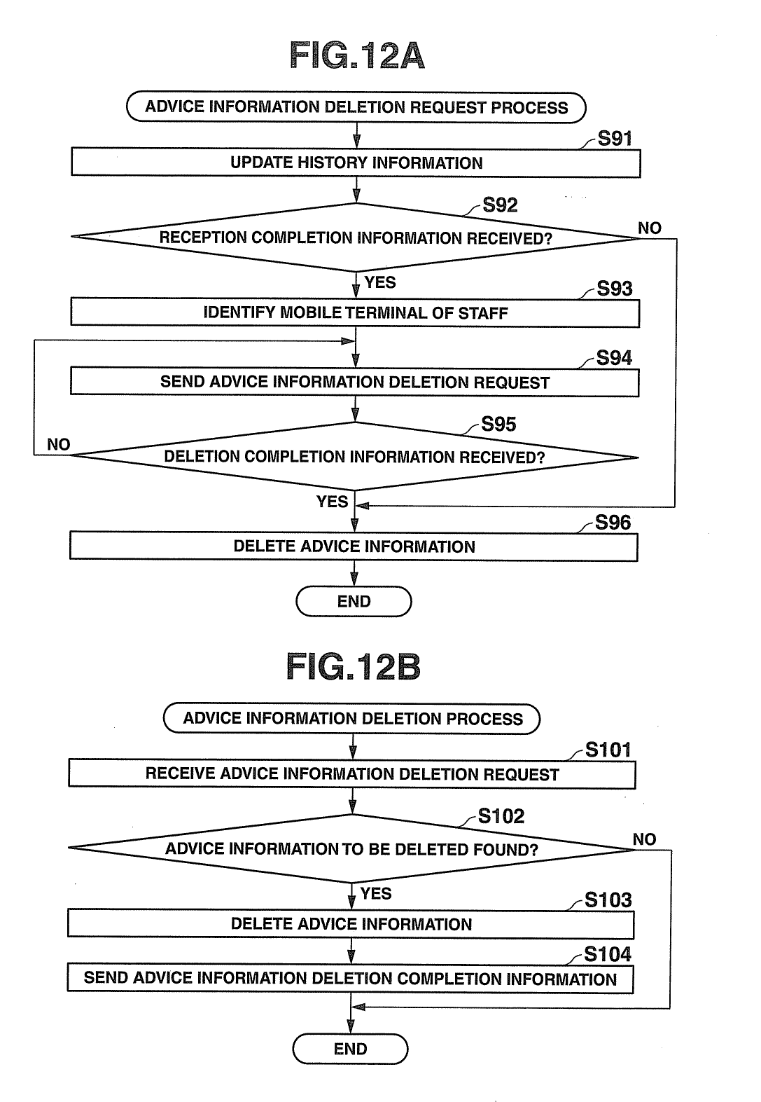

FIG. 12A is a flow chart illustrating an advice information deletion request process executed on the information management device 10.

FIG. 12B is a flow chart illustrating an advice information deletion process executed on the mobile terminal 30A.

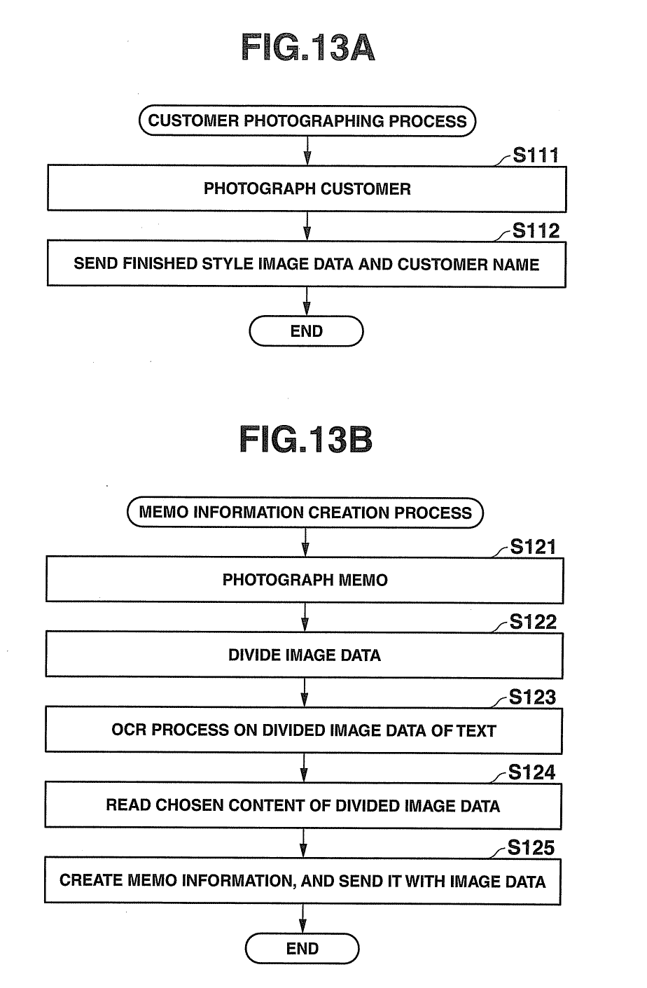

FIG. 13A is a flow chart illustrating a customer photographing process executed on the mobile terminal 30A.

FIG. 13B is a flow chart illustrating a memo information creation process executed on the mobile terminal 30A.

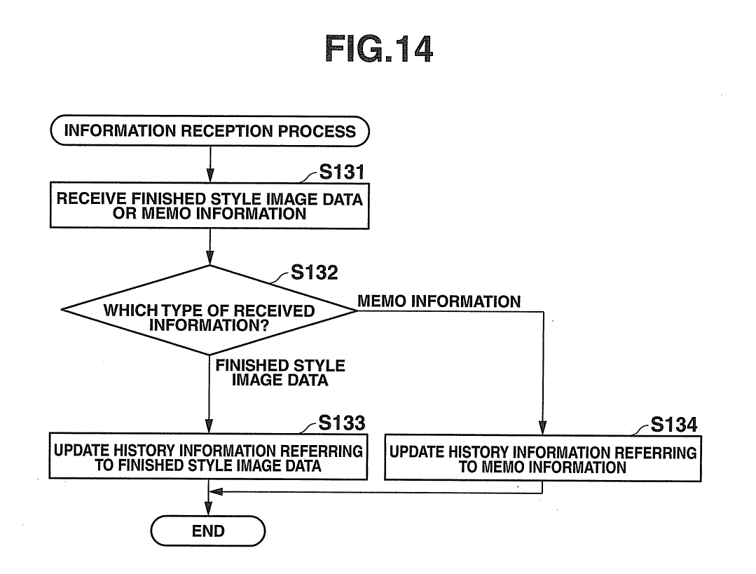

FIG. 14 is a flow chart illustrating an information reception process executed by the information management device 10.

First, the advice information transmission process executed on the information management device 10 will be explained referring to FIGS. 7 and 8. The advice information transmission process is a process of creating the advice information on the information management device 10, and sending it to the mobile terminal 30A, 30B or 30C.

It is now assumed that the staff information 50 and the customer information 60 are preliminarily stored in the storage unit 17. It is also assumed that, when the shop receives an appointment for the service from the customer by telephone, the appointment information 70 is created based on an entry made by a reception clerk through the operating unit 12, and is stored in the storage unit 17. It is also assumed that the history information 80 regarding the past service is stored in the storage unit 17.

Each staff of the shop determines which of the mobile terminals 30A, 30B and 30C to use, and properly logs in to the information management device 10. For example, in the mobile terminal 30A, the CPU 31 accepts an entry of the account and the password of the staff through the operating unit 32, and sends them through the wireless communication unit 36 to the information management device 10.

In the information management device 10, the CPU 11 receives the account and the password of the staff through the communication unit 16 from the mobile terminal 30A, and authenticates the login using the staff account and the staff password contained in the customer information 60 stored in the storage unit 17, and sends a result of authentication to the mobile terminal 30A to complete the login process. In the following paragraphs, an exemplary case of a staff “Nihon Taro” using the mobile terminal 30A will be explained.

In the information management device 10, for example, corresponding to visit of the customer to the shop, and as triggered by an entry of an execution command of the advice information transmission process made by the reception clerk through the operating unit 12, the CPU 11 executes the advice information transmission process in cooperation with the advice information transmission program 151 read out from the ROM 15 and properly loaded into the RAM 13.

As illustrated in FIG. 7, first, the CPU 11 accepts an entry of the customer name entered by the reception clerk through the operating unit 12, and acquires the appointment information 70 having the customer name for the applicant, from the storage unit 17 (step S11). The CPU 11 then determines whether the appointment information 70 acquired in step S11 is found or not (step S12). If the appointment information 70 was found (step S12; YES), the CPU 11 executes the advice information creation process (step S13).

Referring now to FIG. 8, the advice information creation process in step S13 will be explained. First, the CPU 11 reads out a staff in the appointment information 70, and reads out the staff information 50 having the staff name of the thus-read staff, from the storage unit 17 (step S31). The CPU 11 then reads out the applicant in the appointment information 70, and reads out the customer information 60 having the thus-read applicant for the customer name, from the storage unit 17 (step S32).

The CPU 11 then reads out the applicant in the appointment information 70, and reads out the history information 80 having the thus-read applicant for the customer name, from the storage unit 17 (step S33). The CPU 11 then reads out a conversation keyword information 90 from the storage unit 17, reads out a hospitality memo in the history information 80 read out in step S33, and extracts a keyword in the conversation keyword information 90 (step S34). While it is assumed in this example that the keyword is extracted from the hospitality memo in the history information 80 regarding the last visit service under the same customer name, the extraction is not limited thereto. For example, the keyword may be extracted from the hospitality memo for the time-before-last or earlier.

The CPU 11 then conducts, by using the keyword extracted in step S34, Internet search through the communication unit 16 on websites on the communication network N, and acquires related information regarding the keyword from servers of the websites (step S35). For an exemplary case where the keyword is “ski”, contents of the related information regarding “ski” may be “we have much snow in this season, so we can enjoy powder snow this weekend”.

In step S35, another possible configuration is such as preliminarily installing a server of an information providing site for providing the related information regarding the keyword, which is convenient for conversation, on the communication network N, and allowing the CPU 11 to send the keyword through the communication unit 16 to the server of the information providing site, and to receive the related information regarding the keyword.

Still another possible configuration is such as allowing the CPU 11 to send the keyword through the communication unit 16 to the servers of given encyclopedia sites, news sites and so forth on the communication network N, and to acquire the related information regarding the keyword.

The CPU 11 then creates the advice information 100 by using the customer information 60 read out in step S32 and the appointment information 70 read out in step S11 to configure the customer information section 100a, using the history information 80 read out in step S33 to configure the history information section 100b, and using the related information acquired in step S35 to configure the related information section 100c, and stores the advice information 100 into the storage unit 17 (step S36), to thereby complete the advice information creation process.

Referring now back to FIG. 7, after step S13, or if the appointment information 70 is not found (step S12; NO), the CPU 11 acquires date and time of visit from the time-counting unit 20, creates visiting information which includes the date and time of visit, the customer name acquired in step S11 and the staff name in the appointment information 70, and the history information 80, and stores them into the storage unit 17 (step S14). If the appointment information is not found in step S14, the visiting information and the history information 80 do not contain the staff name.

The CPU 11 then determines whether the appointment information 70 is absent or not in step S12 (step S15). If the appointment information 70 is absent (step S15; YES), the CPU 11 reads out the customer information 60 from the storage unit 17, and searches any information containing the customer name entered in step S11 (step S16). The CPU 11 then determines whether the customer who came to the shop but the name of which was not found in step S16, is a new customer or not (step S17).

If the customer is a new customer (step S17; YES), the CPU 11 accepts entries of an address and the date of birth of the new customer, entered by the reception clerk through the operating unit 12, creates new customer information 60 which contains these information, the customer name acquired in step S11, and the date and time of visit acquired in step S14, and stores it into the storage unit 17 (step S18).

The CPU 11 then accepts an entry for selecting a staff responsible for the customer who came to the shop, entered by the reception clerk through the operating unit 12, among the staffs contained in the staff information 50, and updates the visiting information and the history information 80 created in step S14, by incorporating therein the staff name of the staff (step S19). If the customer is not a new customer (step S17; NO), the process advances to step S19.

The CPU 11 then executes the advice information creation process corresponding to the customer name and the staff name acquired in step S19 (step S20). In the advice information creation process in step S20, the staff information 50 of the staff entered in step S19 is read out in step S31, the customer information 60 and the history information 80 which contain the customer name entered in step S11 are read out in steps S32 and S33, where appointment information 70 is not contained in the advice information 100 created in step S36.

The CPU 11 then determines whether the staff identified by the staff name acquired in step S11 or S19 is currently logged in (step S21). If the appointment information 70 is not absent (step S15; NO), the process advances to step S21.

If the staff is not logged in (step S21; NO), the CPU 11 prepare an email which asks the staff to log in, and sends it through the communication unit 16, to the staff email address in the staff information 50 corresponding to the staff (step S22). The process then advances to step S21.

If the staff is logged in (step S21; YES), the CPU 11 sends the visiting information directed to the staff, through the communication unit 16, to all mobile terminals 30A, 30B and 30C (step S23). The CPU 11 then determines whether a button-touched information is received through the communication unit 16 from the mobile terminal 30A, 30B or 30C (step S24).

The button-touched information indicates that an advice button, which is a button for triggering reception of the advice information 100, is touched on the mobile terminal 30A, 30B or 30C, and is received from the mobile terminal logged in by the staff responsible for the customer who came to the shop.

If the button-touched information is not received (step S24; NO), the process advances to step S24. If the button-touched information is received (step S24; YES), the CPU 11 sends the advice information 100 created in step S13 or S20, through the communication unit 16, to the mobile terminal which is a sender of the button-touched information (step S25), to thereby complete the advice information transmission process.

Next, the advice information display process executed on the mobile terminals 30A, 30B, 30C will be explained referring to FIG. 9. The advice information display process is a process of receiving, on the mobile terminal the staff logged in, the advice information 100 sent from the information management device 10, and displaying it. When providing the service to the customer, the staff refers to the advice information displayed on the mobile terminal that he or she carries, to give proper advice and conversation. While the paragraphs below will deal with execution of the advice information display process on the mobile terminal 30A, the same will also apply to the mobile terminals 30B and 30C.

In the mobile terminal 30A, for example triggered by power-on, the CPU 31 executes the advice information display process, in cooperation with the advice information display program 351 read out from the ROM 35 and properly loaded into the RAM 33.

First, the CPU 31 executes processes of other jobs (step S41). The processes of other jobs refer to the processes other than the advice information display process, and also include a logging-in process to the information management device 10.

Corresponding to step S23 in the advice information transmission process, the CPU 31 determines whether the visiting information is received through the wireless communication unit 36 from the information management device 10 (step S42). If the visiting information is not received (step S42; NO), the process advances to step S41.

When the visiting information is received (step S42; YES), the CPU 31 decides whether the visiting information received in step S42 is directed to the staff who logged in on its own terminal, or not (step S43). If the visiting information is not directed to the staff who logged in on its own terminal (step S43; NO), the process advances to step S41. If the visiting information is directed to the staff who logged in on its own terminal (step S43; YES), the CPU 31 displays the visiting information, together with the advice button on the display unit 34 (step S44).

The CPU 31 then determines whether the staff touches the advice button on the operating unit 32 or not (step S45). If the advice button is not touched (step S45; NO), the process advances to step S41.

If the advice button is touched (step S45; YES), corresponding to step S24 in the advice information transmission process, the CPU 31 sends the button-touched information regarding the advice button, through the wireless communication unit 36 to the information management device 10 (step S46).

Corresponding to step S25 in the advice information transmission process, the CPU 31 receives the advice information 100 through the wireless communication unit 36 from the information management device 10, and stores it into the storage unit 37 (step S47). Alternatively, the advice information 100 may be stored in the RAM 33.

The CPU 31 then sends reception completion information regarding the advice information 100, through the wireless communication unit 36 to the information management device 10 (step S48). The CPU 31 then determines whether the customer information section 100a is found in the advice information 100 received in step S47 (step S49). If the customer information section 100a is found (step S49; YES), the CPU 31 displays the customer information section 100a as the advice information on the display unit 34 (step S50).

The CPU 31 then determines whether the history information for the last visit is found in the history information section 100b of the advice information 100 (step S51).

If the customer information section 100a is not found (step S49; NO), the process advances to step S51. If the history information for the last visit is found (step S51; YES), the CPU 31 displays the history information for the last visit, excluding the last visit retail goods, in the history information section 100b of the advice information 100, as the advice information onto the display unit 34 (step S52).

If the history information for the last visit is not found (step S51; NO), the history information section 100b is not found as a consequence, so that the advice information display process comes to the end.

The CPU 31 acquires current date and time from the time-counting unit 38, calculates the number of days counted from the date and time of last visit up to the current date and time, referring to the date and time of last visit in the history information section 100b, and displays it as the advice information onto the display unit 34 (step S53). The CPU 31 then compares the number of days calculated in step S53 and a preliminarily-set threshold value of cycle of visit (step S54). The threshold value of cycle of visit represents the number of days of cycle of visit suitable for the customer.

The CPU 31 determines whether the number of days calculated in step S53 exceeds the threshold value of cycle of visit or not (step S55). If the number of days is found to exceed the threshold value of cycle of visit (step S55; YES), the CPU 31 displays the cycle of visit alert information on the display unit 34 (step S56). The cycle of visit alert information is alert information for prompting the staff to propose a proper cycle of visit to the customer.

The CPU 31 then determines whether last visit retail goods is found in the history information section 100b of the advice information 100 (step S57). If the number of days does not exceed the cycle of visit information (step S55; NO), the process advances to step S57. If the last visit retail goods are found (step S57; YES), the CPU 31 displays the last visit retail goods as the advice information on the display unit 34 (step S58).

The CPU 31 then determines whether the history information of visit earlier than the last visit is found in the history information section 100b of the advice information 100 (step S59). If the last visit retail goods are not found (step S57; NO), the process advances to step S59. If the history information of visit earlier than the last visit is found (step S59; YES), the CPU 31 displays the history information of visit earlier than the last visit, as the advice information on the display unit 34 (step S60). In step S60, displayed for example is a button, touching on which allows the staff to display the history information of visit earlier than the last visit.

The CPU 31 then determines whether the related information section 100c is found in the advice information 100 (step S61). If the history information of visit earlier than the last visit is not found (step S59; NO), the process advances to step S61. If the related information section 100c is found (step S61; YES), the CPU 31 displays the related information section 100c as the advice information on the display unit 34 (step S62), to thereby complete the advice information display process. If the related information section 100c is not found (step S61; NO), the advice information display process comes to the end.

Now, an exemplary advice information displayed in the advice information display process will be explained.

A case discussed herein is shown in FIG. 10, where an advice information screen 200 is displayed by the advice information display process.

The advice information screen 200 contains a customer name 210, a number of times of visit 220, appointment information 230, customer information 240, a record card 250, last visit history information 260, a two visits ago history information button 270, a three visits ago history information button 280 and a further earlier visit history information button 290.

The customer name 210 is based on the customer name in the customer information section 100a of the advice information 100.

The number of times of visit 220 is based on the number of times of visit in the customer information section 100a of the advice information 100.

The appointment information 230 is based on the date and time of appointment, the reserved course, the staff, the special notes for appointment and the style image data at appointment in the customer information section 100a of the advice information 100.

In the appointment information 230, a photographic image is displayed as the style image data at appointment.

The customer information 240 is based on the date of birth (age) in the customer information section 100a of the advice information 100, and the date and time of first visit and the cycle of visit (average) in the history information section 100b.

The record card 250 is based on the record card in the customer information section 100a of the advice information 100.

The last visit history information 260 is based on the date and time of last visit, last visit service course, last visit staff, last visit finished style image data, the last visit retail goods, the last visit service detail memo, the last visit hospitality memo, and the image data of last visit memo in the history information section 100b of the advice information 100, and also based on the related information section 100c.

The last visit history information 260 contains number of days 261, and cycle of visit alert information 262. The number of days 261 is the one calculated in step S53 of the advice information display process. The cycle of visit alert information 262 is the one displayed in step S56 of the advice information display process.

Upon touching of the two visits ago history information button 270, the two visits ago history information is displayed in the same way with the last visit history information 260. Upon touching of the three visits ago history information button 280, the three visits ago history information is displayed in the same way with the last visit history information 260. Upon touching of the further earlier visit history information button 290, a screen allowing the staff to selectively enter the time of visit earlier than the three visits ago is displayed, and the visit history information corresponding to the selected time is displayed.

Immediately before the service, the staff verifies the customer by using the customer name 210, expresses his or her thanks to the customer referring to the number of times of visit 220, and verifies details of the appointment referring to the appointment information 230. The staff provides service to the customer, for example, referring to the customer information 240, the record card 250 and the last visit history information 260.

In particular, the staff uses the record card 250, the service detail memo of the last visit history information 260, the finished style image data and the image data of memo and the like as technical referential information for the current service. The staff may also recommend new retail goods to the customer, referring to the retail goods in the last visit history information 260. The staff may also provide advice to the customer about a proper timing of service for the future, referring to the number of days 261 and the cycle of visit alert information 262.

The staff may have a conversation with the customer, while glancing at the hospitality memo in the last visit history information 260 and referring to the topic at the last visit, and may give related information regarding the keyword of the conversation in the hospitalization of the last visit, referring to the related information in the last visit history information 260.

Next, the service course end information transmission process executed by the information management device 10 will be explained referring to FIG. 11A.

The service course for the customer includes a course of main services such as cut, styling and so forth provided by the staff in a service area of the shop, and a shampoo course provided by an assistant of the staff in a hair-washing area. The shampoo course is properly inserted in the process of main styling course, as necessary.

While the description below will explain a configuration wherein the assistant of the staff is engaged in the shampoo course in the hair-washing area, the present invention is not limited thereto. Another possible configuration is such that the assistant of the staff is engaged in massaging the customer in a massaging space.

Upon completion of shampoo course of the customer, the assistant of the staff moves to the reception counter. The service course end information transmission process is a process of sending the service course end information, which represents the end of shampoo course, to the mobile terminal of the staff, in response to entry operation by the assistant.

In the information management device 10, for example triggered by an entry of a command for executing the service course end information transmission process, entered by the assistant of the staff through the operating unit 12, the CPU 11 executes the service course end information transmission process, in cooperation with the service course end information transmission program 152 read out from the ROM 15 and properly loaded into the RAM 13.

First, the CPU 11 reads out the visiting information from the storage unit 17, creates a list of in-shop customers currently staying in the shop, and displays it on the display unit 34 (step S71). The CPU 11 then accepts, through the operating unit 12 from the assistant of the staff, a selective entry of the customer who went through the service course in the list of in-shop customers (step S72).

The CPU 11 then accepts, through the operating unit 12 from the assistant of the staff, a selective entry of the finished service course (step S73). In step S73, for example, the shampoo course is selected.

The CPU 11 then identifies a staff corresponding to the customer selected in step S72, referring to the visiting information, creates the service course end information which includes the customer name of the customer and indication describing the end of the service course selected in step S73, and sends the service course end information directed to the staff, through the communication unit 16 to all of the mobile terminals 30A, 30B and 30C (step S74), to thereby complete the service course end information transmission process.

Next, the service course end information display process executed on the mobile terminals 30A, 30B and 30C will be explained referring to FIG. 11B.

The service course end information display process is a process of receiving and displaying the service course end information sent from the information management device 10. While the paragraphs below will deal with the case where the mobile terminal 30A executes the service course end information display process, the same will also apply to the mobile terminals 30B and 30C.

In the mobile terminal 30A, for example triggered by power-on, the CPU 31 executes the service course end information display process, in cooperation with the service course end information display program 352 read out from the ROM 35 and properly loaded into the RAM 33.

First, the CPU 31 executes processes of other jobs (step S81). The processes of other jobs refer to processes other than the service course end information display process.

Corresponding to step S74 in the service course end information transmission process, the CPU 31 determines whether the service course end information is received through the wireless communication unit 36 from the information management device 10 or not (step S82). If the service course end information is not received (step S82; NO), the process advances to step S81.

If the service course end information is received (step S82; YES), the CPU 31 determines whether the service course end information received in step S82 is directed to the staff who logged in on its own terminal (step S83). If the service course end information is not directed to the staff who logged in on its own terminal (step S83; NO), the process advances to step S81.

If the service course end information is directed to the staff who logged in on its own terminal (step S83; YES), the CPU 31 displays the end of service course on the display unit 34, in response to the service course end information (step S84). The staff visually checks the service course end information. For example, according to the service course end information regarding the shampoo course, the staff guides the customer from the hair-washing area to the styling area, and provides succeeding processes of the service course.

The CPU 31 then sends the service course end reception completion information which indicates that the service course end information has already been received by the staff who logged in on its own terminal, through the wireless communication unit 36 to the information management device 10 (step S85), to thereby complete the service course end information display process. The CPU 11 of the information management device 10 receives, through the communication unit 16, the service course end reception completion information.

Next, the advice information deletion request process executed on the information management device 10 will be explained referring to FIG. 12A. The advice information deletion request process is a process of requesting the mobile terminal to delete the advice information, in response to the end of accounting.

In the information management device 10, for example triggered by the end of accounting regarding the customer on which the service was finished, the CPU 11 executes the advice information deletion request process, in cooperation with the advice information deletion request program 153 read out from the ROM 15 and properly loaded into the RAM 13.

The accounting is a series of processes including reception of entries of service items by an accountant (reception clerk) through the operating unit 12, calculation of a total fee of the service items and display thereof on the display unit 14, reception of entry regarding cash received from the customer through the operating unit 12, calculation of change and display thereof on the display unit 14, releasing of a cash drawer box of a drawer 19, printing of a receipt by the printing unit 18, and storage of sales data into the storage unit 17.

First, the CPU 11 updates the history information 80 stored in the storage unit 17, upon completion of the accounting (step S91). More specifically, according to information regarding the customer who finished accounting, the header section 80a and the retail goods section 80b are updated.

The CPU 11 then determines whether the reception completion information of the advice information regarding the customer who finished the accounting is received or not, in response to the step S48 in the advice information display process (step S92). If the reception completion information is received (step S92; YES), the CPU 11 identifies the mobile terminal being logged in or logged out by the staff to whom the advice information was sent (step S93).

Any omission of reception of the advice information on the mobile terminal may be verified on the information management device 10, by checking the reception completion information received thereon. The CPU 11 then sends the advice information deletion request regarding the customer who finished the accounting, through the communication unit 16 to the mobile terminal identified in step S93 (step S94).

The CPU 11 then determines whether the deletion completion information regarding the advice information corresponding to step S94 is received or not, through the communication unit 16 from the mobile terminal identified in step S93 (step S95). If the deletion completion information is not received (step S95; NO), the process advances to step S94.

If the deletion completion information is received (step S95; YES), the CPU 11 deletes the advice information 100 regarding the customer who finished the accounting from the storage unit 17 (step S96), to thereby complete the advice information deletion request process. If the reception completion information is not received (step S92; NO), the process advances to step S96.

Next, the advice information deletion process executed on the mobile terminals 30A, 30B and 30C will be explained, referring to FIG. 12B.

The advice information deletion process is a process of deleting the advice information 100 stored in the storage unit 37, in response to the advice deletion request received from the information management device 10. While the paragraphs below will deal with the case where the mobile terminal 30A executes the advice information deletion process, the same will also apply to the mobile terminals 30B and 30C.

In the mobile terminal 30A, for example, corresponding to step S94 in the advice information deletion request process, and triggered by start of reception of the advice information deletion request through the wireless communication unit 36, the CPU 31 executes the advice information deletion process, in cooperation with the advice information deletion program 353 read out from the ROM 35 and properly loaded into the RAM 33.

First, the CPU 31 receives the advice information deletion request through the wireless communication unit 36 (step S101). The CPU 31 then refers to the storage unit 37, and determines whether the advice information 100, which is a target of the advice information deletion request received in step S101, is stored therein or not (step S102).

If the advice information 100 to be deleted is not found (step S102; NO), the advice information deletion process comes to the end. If the advice information 100 to be deleted is found (step S102; YES), the CPU 31 deletes the advice information 100 to be deleted from the storage unit 37 (step S103). The CPU 31 then sends deletion completion information of the advice information 100 to be deleted, through the wireless communication unit 36 to the information management device 10, corresponding to step S95 in the advice information deletion request process (step S104), to thereby complete the advice information deletion process.

Next, the customer photographing process executed on the mobile terminals 30A, 30B and 30C will be explained, referring to FIG. 13A.

The customer photographing process is a process of photographing the head (hairstyle) of the customer after end of the service by the staff, and sending finished style image data to the information management device 10. While the paragraphs below will deal with the case where the mobile terminal 30A executes the customer photographing process, the same will also apply to the mobile terminals 30B and 30C.

In the mobile terminal 30A, for example triggered by an entry of a command for executing the customer photographing process, entered by the staff through the operating unit 32, the CPU 31 executes the customer photographing process in cooperation with the customer photographing program 354 read out from the ROM 35 and properly loaded into the RAM 33.

First, the staff adjusts the direction of photographing of the photographing unit 39 so as to be focused on the head (hairstyle) of the customer as an object to be shot. The CPU 11 accepts an entry of command for photographing through the operating unit 32, allows the photographing unit 39 to photograph the hairstyle of the customer according to the command for photographing so as to create finished style image data, and stores it into the storage unit 37 (step S111).

The CPU 11 then sends the image data obtained by photographing in step S111 through the wireless communication unit 36 to the information management device 10, together with the customer name of the photographed customer (step S112), to thereby complete the customer photographing process.

Next, the memo information creation process executed on the mobile terminals 30A, 30B and 30C will be explained, referring to FIG. 13B. The memo information creation process is a process such that the staff photographs the memo sheet after completion of the service of the customer so as to create read memo information, and sends it to the information management device 10. While the paragraphs below will deal with the case where the mobile terminal 30A executes the memo information creation process, the same will also apply to the mobile terminals 30B and 30C.

The memo sheet has a fixed form preliminarily printed thereon. The memo sheet will, for example, be filled by the staff with information regarding the service after completion of the service of the customer. The memo sheet is now assumed to have, for example, entry columns for customer name, record card, service detail memo, hospitality memo, and image of memo.

The customer name column on the memo sheet is provided for entry of the name of the customer to receive the service. The record card column on the memo sheet is provided for entry of information regarding hair conditions of the customer. In the record card, for example, hair type, volume, thickness and color of hair of the customer are given according to the three-rank system, so as to allow the staff to check the box or encircle the choice. The service detail memo column on the memo sheet is provided for a text entry regarding details of the service. The hospitality memo column on the memo sheet is provided for a text entry regarding the contents of talk of the customer. The image of memo column on the memo sheet is provided for a graphic entry of details of service of the customer, and the like.

In the mobile terminal 30A, for example triggered by the entry of a command for executing the memo information creation process, entered by the staff through the operating unit 32, the CPU 31 executes the memo information creation process, in cooperation with the memo information creating program 355 read out from the ROM 35 and properly loaded into the RAM 33. The memo information creation process may take place every time the service of the customer is completed, in an intermission of the staff, or after business hours of the day of the salon.

First, the staff adjusts the direction of photographing of the photographing unit 39 so as to be focused on the memo sheet. The CPU 31 accepts an entry of command for photographing through the operating unit 32, allows the photographing unit 39 to photograph the memo sheet according to the command for photographing so as to create image data (sheet image data), and stores it into the storage unit 37 (step S121).

The CPU 31 then divides the memo image data captured in step S121, by using formatting data (not illustrated) stored in the storage unit 37, to thereby create divided image data for every entry column (step S122). The formatting data contains information for identifying entry columns, division coordinate data indicating segmented regions of the entry columns, conversion coordinate data indicating information conversion (reading) regions of the entry columns, attributes of entry into the entry columns (text, check, encircle), and contents of choice for the entry columns with the choice attribute (check, encircle).

Using the formatting data, the CPU 31 then reads the divided image data which is created in step S122 and has text attribute, by OCR (Optical Character Reading) process, to thereby acquire text data (step S123). Using the formatting data, the CPU 31 then reads the divided image data which is created in step S122 and has the choice attribute (check, encircle), to thereby acquire text data regarding the chosen content (step S124).

The CPU 31 then creates memo information having therein the divided image data which contains graphic memo image data created in step S122, and the text data created in steps S123 and S124 assigned to the individual items, and sends the memo information together with the sheet image data and the divided image data, through the wireless communication unit 36 to the information management device 10 (step S125), to thereby complete the memo information creation process.

Next, the information reception process executed by the information management device 10 will be explained, referring to FIG. 14. The information reception process is a process of updating the history information 80 stored in the storage unit 17, according to the information received from the mobile terminal.

In the information management device 10, for example triggered by start of the reception of the finished style image data and customer name, or memo information, the sheet image data and the divided image data, through the wireless communication unit 36, corresponding to step S112 in the customer photographing process or step S125 in the memo information creation process, the CPU 11 executes the information reception process in cooperation with the information reception program 154 read out from the ROM 15 and properly loaded into the RAM 13.

First, the CPU 11 completes reception, through the wireless communication unit 36, of the finished style image data and the customer name, or the memo information, the sheet image data and the divided image data (step S131) The CPU 11 then determines the type of the information received in step S131 (step S132). If the received information contains the finished style image data and the customer name (step S132; finished style image data), the CPU 11 updates the finished style image data in the header section 80a of the history information 80 stored in the storage unit 17, according to the received finished style image data and the customer name, and stores the finished style image data in the storage unit 17 (step S133), to thereby complete the information reception process.

If the received information contains the memo information, the sheet image data and the divided image data (step S132; memo information), the CPU 11 updates the memo section 80c of the history information 80 stored in the storage unit 17, according to the thus-received memo information and the divided image data, and stores the sheet image data and the divided image data into the storage unit 17 (step S134), to thereby complete the information reception process.

As described in the above, according to this embodiment, the information management device 10 creates the advice information used for advising the customer, sends the advice information to the mobile terminal used by the staff responsible for the customer, and sends the advice information deletion request to the mobile terminal, at a predetermined timing after transmission of the advice information. Each of the mobile terminals 30A, 30B and 30C receives the advice information from the information management device 10, stores it into the storage unit 37, displays it on the display unit 34, and deletes the advice information 100 stored in the storage unit 37, when the advice information deletion request is received from the information management device 10.

Accordingly, the advice information is received by the mobile terminal, displayed thereon, and is therefore readily informed to the staff. Since the advice information is deleted after it is displayed, the advice information may be prevented from leaking out from the mobile terminal, even if the mobile terminal having the advice information received therein is accidentally lost. Since the advice information is displayed on the mobile terminal of the staff, the staff no longer needs to move from the area where the service is provided to the area where the information management device 10 is installed (reception counter), and so that the load of working of the staff may be relieved.

The predetermined timing after transmission of the advice information is the timing when the accounting of the customer corresponding to the advice information completes. Accordingly, the advice information can surely be deleted for every accounting, the risk of leakage of the advice information for the customer can be minimized since the advice information is available only when the customer stays in the shop, and the advice information can be deleted at an appropriate timing without deleting it before the accounting where the advice information needs to be displayed.

The information management device 10 creates the advice information which contains the individual information regarding the customer information 60 for the customer to be advised and the history information stored in the storage unit 17. Accordingly, the staff can acquire the customer information, and can give advice to the customer based on the service history referring to the history information.

The information management device 10 creates the advice information which contains the individual information regarding the appointment information 70, in addition to the customer information 60 for the customer to be advised and the history information 80 which are stored in the storage unit 17. The staff can therefore visually verify the appointment information in an exact manner.

The information management device 10 extracts a predetermined keyword from the hospitality memo regarding the contents of talk of the customer in the last visit hospitalization contained in the memo section 80c of the history information 80, acquires related information relevant to the extracted keyword through the communication unit 16 from equipment on the Internet, and creates the advice information which contains the hospitality memo and the related information. Accordingly, the staff can explain the customer about the related information regarding the contents of talk of the customer for the past (previous visits), and can provide appropriate related information suitable for the customer.

Upon entry of the command for receiving the advice information into the operating unit 32 by touching the advice button, the mobile terminal receives the advice information from the information management device 10, and displays it on the display unit 34. Accordingly, the advice information is successfully prevented from being received by, or displayed on the mobile terminal without being directed by the staff, so that for example the advice information may be prevented from being peeped by someone other than the staff, even if the staff accidentally left the mobile terminal elsewhere.

Upon reception of the advice information, the mobile terminal determines whether the number of days counted from the last visit date and time of visit contained in the advice information, up to the current date and time exceeds the threshold value of cycle of visit, and if it exceeds, displays that the elapsed time exceeds the threshold value of cycle of visit on the display unit 34. Accordingly, if the customer came behind the threshold value of cycle of visit, the staff who noticed it may propose an appropriate cycle of visit to the customer, or may prompt the customer to shorten his or her cycle of visit, typically by giving away a discount voucher.

Upon entry of the end of service course entered by the assistant of the staff responsible for the customer corresponding to the advice information through the operating unit 12, the information management device 10 sends the service course end information to the mobile terminal. Upon reception of the service course end information, the mobile terminal displays the end of the service course in the display unit 34, in response to the service course end information. Accordingly, the staff may visually verify the end of service course in a more exact manner.

Note that the description of the embodiment above is given merely for exemplifying the information management device, the information management system and the program of the present invention, to which the present invention is by no means limited.

While the information management device 10 described in the embodiment above is configured to send, after the accounting, the advice information deletion request to the mobile terminal, to thereby delete the advice information, the configuration is not limited thereto. For example, another possible configuration is such as allowing the information management device 10 to send the advice information deletion request to the mobile terminal, at a predetermined timing after transmission of the advice information to the mobile terminal, so as to delete the advice information. According to this configuration, a risk of leakage of the advice information may be minimized, since the advice information may surely be deleted in a predetermined duration after the transmission of the advice information and the advice information is available only over the predetermined duration. The predetermined duration is preferably set so as to cover a duration up to the end of hospitalization (service) by the staff.

While the information management system 1 in the embodiment above was configured for use at beauty salon, the application is not limited thereto. The information management system 1 may be configured also for use at barber, massage salon, aesthetic salon, nail salon, acupuncture and moxibustion clinic, tutorial gym and other shops where the staffs provide services to the customers.

While the information management device 10 in the embodiment above was configured to allow the assistant as some other staff to enter the end of service course through the operating unit 12, the configuration is not limited thereto. For example, in one possible configuration, the some other staff may carry the mobile terminal, and may enter, upon completion of the service course by the some other staff, the end of service course by an operation on the mobile terminal, so as to send the information regarding the end of service course from the mobile terminal to the information management device 10.

While the mobile terminal in the embodiment above was configured to display the end of service course according to the received service course end information, the configuration is not limited thereto. For example, the mobile terminal may be configured to have, as the informing unit, at least one of display unit, lamp such as LED (Light Emitting Diode), vibrator and loudspeaker, so as to announce the end of service course by at least one of display on the display unit, illumination of the lamp, vibration of the vibrator and sound output from the loudspeaker.

The advice information may also contain other information including service point or stamp, shop-specific information (information on new arrival, promotion of campaign, etc.) While the information management device 10 and the mobile terminals 30A, 30B and 30B in the embodiment above were configured as separate bodies, the configuration is not limited thereto. Another possible configuration is such as using a single information processing device, in which functions of the information management device and the mobile terminals may be switched by an application program which runs thereon.

It goes without saying that various changes can be made within the scope of the present invention with respect to the detailed configuration and detailed operation of the components of the information management system 1 in the embodiment.

Though the embodiments of the present invention have been explained as mentioned above, the scope of the present invention is not limited to the above-mentioned embodiments and includes a scope of the invention described in claims and the equivalents thereof.

The entire disclosure of Japanese Patent Application No. 2012-133432 filed on Jun. 13, 2012 including description, claims, drawings, and abstract are incorporated herein by reference in its entirety.

What is claimed is:

1. An information management device which communicates with a mobile terminal, comprising:
a creating unit which creates advice information to be displayed on the mobile terminal for giving advice to a customer;
a transmitting unit which transmits the advice information to the mobile terminal; and
a requesting unit which transmits, to the mobile terminal, a deletion request for deleting the advice information, at a predetermined timing after transmission of the advice information.

2. The information management device according to claim 1, wherein the predetermined timing is a timing of the end of payment by the customer corresponding to the advice information.

3. The information management device according to claim 1, wherein the predetermined timing is a timing when a predetermine period of time has elapsed after transmission of the advice information.

4. The information management device according to claim 1, further comprising a first storage unit which stores customer information for each customer and history information of service to the customer,
wherein
the creating unit creates advice information which contains the customer information and the history information of the customer to be advised that are stored in the first storage unit.

5. The information management device according to claim 4, wherein
the first storage unit stores appointment information of the customer, and
the creating unit creates advice information which contains the customer information, the history information and the appointment information of the customer to be advised that are stored in the first storage unit.

6. The information management device according to claim 4, wherein
the information management device is connected to a communication network having a device which provides information,
the history information contains memo information about contents of talk of the customer being served, and
the creating unit extracts a predetermined keyword from the memo information about the contents of talk contained in the history information, acquires related information relevant to the extracted keyword from the device on the communication network, and creates advice information containing the memo information and the related information.

7. An information management system, comprising:
the information management device and the mobile terminal according to claim 1,
wherein
the mobile terminal, includes:
a second storage unit which stores information;
a display unit;
a receiving unit which receives the advice information and the deletion request from the information management device; and
a control unit which stores the received advice information in the second storage unit, displays the advice information on the display unit, and deletes, upon reception of the deletion request, the advice information stored in the second storage unit.

8. The information management system according to claim 7,
wherein
the mobile terminal has an operating unit which accepts an instruction input for reception of the advice information, and
upon issuing of the instruction input for reception of the advice information to the operating unit, the control unit makes the receiving unit receive the advice information, and displays the advice information on the display unit.

9. The information management system according to claim 7,
wherein
the advice information contains date and time information of last visit, and
the control unit determines, upon reception of the advice information, whether an elapsed time from the date and time of last visit in the advice information up to a current date and time of visit exceeds a threshold value of cycle of visit, and if exceeds, displays an indication describing that the elapsed time exceeds the threshold value of cycle of visit, on the display unit.

10. The information management system according to claim 7,
wherein
the mobile terminal has an informing unit,
upon entering of the end of a service course conducted by a staff other than a staff responsible for the customer corresponding to the advice information, the transmitting unit transmits, to the mobile terminal, service course end information which indicates the end of the service by the other staff,
the receiving unit receives the service course end information from the information management device, and
the control unit makes the informing unit inform the end of the service course in response to the received service course end information.

11. A non-transitory computer readable medium that stores a program for making a computer of an information management device which communicates with a mobile terminal execute a procedure, the procedure, comprising:
creating advice information to be displayed on the mobile terminal for giving advice to a customer;
transmitting the advice information to the mobile terminal; and
transmitting, to the mobile terminal, a deletion request for deleting the advice information, at a predetermined timing after transmission of the advice information.
